(19) United States
(12) Patent Application Publication
(10) Pub. No.: US 2010/0217901 A1
(43) Pub. Date: Aug. 26, 2010

(54) Wireless Universal Serial Bus Apparatus and Operating Method Thereof

(76) Inventor: Dong Hee Han, Hwasung-si (KR)

Correspondence Address: F. CHAU & ASSOCIATES, LLC, 130 WOODBURY ROAD, WOODBURY, NY, 11797, US

(21) Appl. No.: 12/709,944

(22) Filed: Feb. 22, 2010

(30) Foreign Application Priority Data
Feb. 24, 2009 (KR) 10-2009-0015438

(51) Int. Cl. G06F 13/42

(52) U.S. Cl. 710/106

(57) ABSTRACT

A wireless universal serial bus (WUSB) apparatus and an operating method thereof includes a WUSB host inserting time information about when a next micro-scheduled management command (MMC) packet will be sent in a WUSB channel stop information element (IE), generating and sending an MMC packet including the WUSB channel stop IE to a WUSB device, the WUSB device receiving the MMC packet including the WUSB channel stop IE from the WUSB host, extracting the time information from the WUSB channel stop IE about when the next MMC packet will be sent, and performing synchronization with the WUSB host based on the time information.

### CROSS-REFERENCE TO RELATED APPLICATIONS

This application claims priority under 35 U.S.C. §119(e) to Korean Patent Application No. 10-2009-0015438 filed on Feb. 24, 2009 in the Korean Intellectual Property Office, the disclosure of which is herein incorporated by reference in its entirety.

### BACKGROUND

1. Technical Field

The present inventive concept relates to a wireless universal serial bus (WUSB) system, and more particularly, to a WUSB apparatus for reducing power consumption of a WUSB system and an operating method thereof.

2. Description of Related Art

In WUSB technology based on the WiMedia Ultra-WideBand (UWB) technical specification, a WUSB host continuously sends a micro-scheduled management command (MMC) packets. One or more WUSB devices periodically receive the MMC packets sent from the WUSB host to maintain a connection to the WUSB host. Typically, wireless equipment enters into a sleep mode when it has not operated for a predetermined period of time and thereby reduces power consumption. When the WUSB host is in an active mode and a WUSB device is in the sleep mode, the WUSB device needs to connect to the WUSB host periodically (e.g., at least once every four seconds) to maintain the connection to the WUSB host. The WUSB host continuously sends the MMC packet (e.g., at least one every several tens of microseconds), and therefore, even when the WUSB device does not receive the MMC packet in the sleep mode and loses the synchronization with the WUSB host, the WUSB device can receive the MMC packet and synchronize with the WUSB host within a short time after waking from the sleep mode.

When all WUSB devices enter the sleep mode, the WUSB host may also enter the sleep mode to reduce power consumption. After entering the sleep mode, the WUSB host sends the MMC packet every at a lower frequency (e.g., at least once every four seconds) to check if there is a remote wakeup request from any of the WUSB devices. In this case, however, there is no way for the WUSB devices in the sleep mode to synchronize with the MMC packet sent from the WUSB host, and therefore, the WUSB devices need to exit a sleep mode for an extended time (e.g., for up to four seconds) to receive the MMC packet.

That the WUSB devices wake from the sleep mode for an extended time to receive the MMC packet is inefficient in terms of power management and also contradicts the purpose of entering the sleep mode during a standby period to reduce power consumption.

### SUMMARY

According to some exemplary embodiments of the present inventive concept, an operating method of a WUSB device includes receiving a micro-scheduled management command (MMC) packet including a WUSB channel stop LE from a WUSB host, extracting time information from the WUSB channel stop IE about when a next. MMC packet will be sent from the WUSB host, and performing synchronization with the WUSB host based on the time information.

The performance of the synchronization may include waking the WUSB device from the sleep mode when the WUSB host sends the next MMC packet and receiving the next MMC packet based on the time information.

According to other exemplary embodiments of the present inventive concept, an operating method of a WUSB host includes inserting time information about when a next MMC packet will be sent in a WUSB channel stop IE; generating an MMC packet including the WUSB channel stop IE; and sending the generated MMC packet to a WUSB device.

The WUSB channel stop IE may contain the time information about when the next MMC packet will be sent. The time information may be contained in a field, e.g., a wakeup time field, included in the WUSB channel stop IE.

### BRIEF DESCRIPTION OF THE DRAWINGS

The present inventive concept will become more apparent by describing in detail exemplary embodiments thereof with reference to the attached drawings in which:

FIG. 1 is a schematic diagram of the structure of a wireless universal serial bus (WUSB) system according to an exemplary embodiment of the present inventive concept;

FIG. 2 is a schematic functional diagram of a WUSB host according to an exemplary embodiment of the present inventive concept;

FIG. 3 is a schematic functional diagram of a WUSB device according to an exemplary embodiment of the present inventive concept;

FIG. 4 is a diagram showing the state transition of a conventional WUSB device;

FIG. 5 is a diagram showing the state transition of a WUSB device according to an exemplary embodiment of the present inventive concept;

FIG. 6 is a flowchart of an operating method of a WUSB apparatus or a WUSB host according to an exemplary embodiment of the present inventive concept; and

FIG. 7 is a flowchart of an operating method of a WUSB apparatus or a WUSB device according to an exemplary embodiment of the present inventive concept.

### DETAILED DESCRIPTION OF EXEMPLARY EMBODIMENTS

The present inventive concept now will be described more fully hereinafter with reference to the accompanying drawings, in which embodiments of the invention are shown. This invention may, however, be embodied in many different forms and should not be construed as limited to embodiments set forth herein. Rather, embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

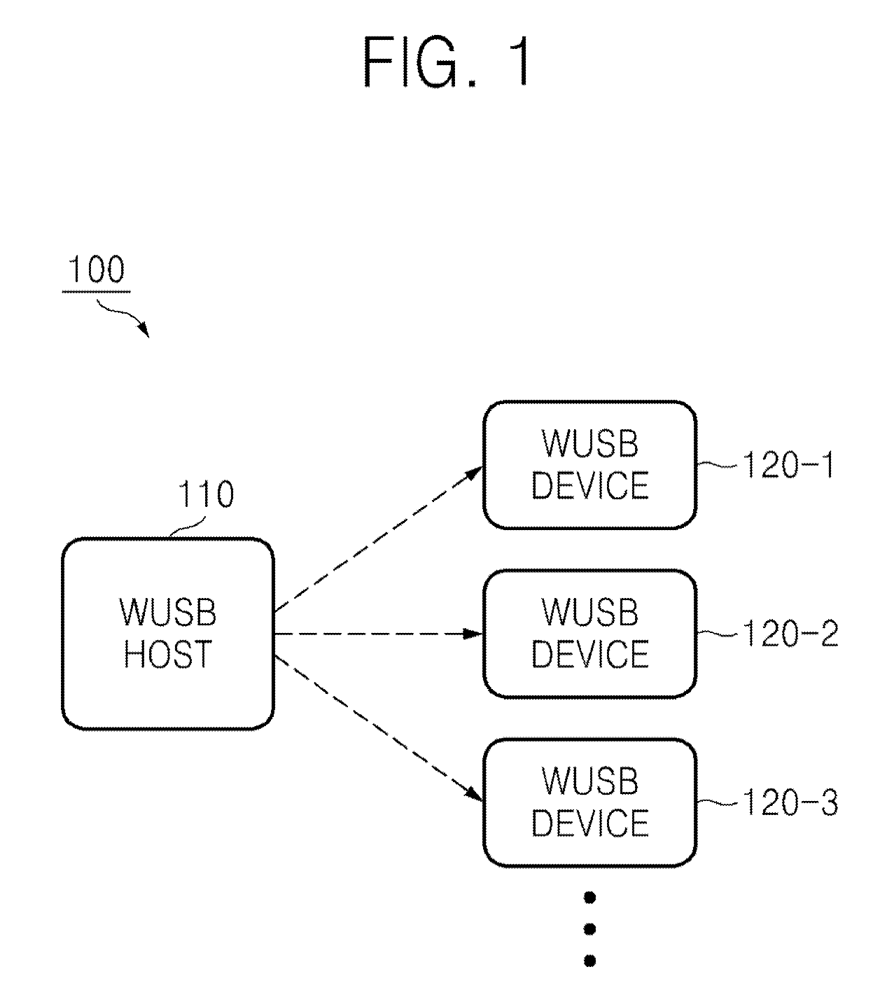

FIG. 1 is a schematic diagram of the structure of a wireless universal serial bus (WUSB) system 100 according to an exemplary embodiment of the present inventive concept. The WUSB system 100 includes a WUSB host 110 and a plurality of WUSB devices 120-1 through 120-3. The WUSB host 110 enters a sleep mode only when all of the WUSB devices 120-1 through 120-3 connected to the WUSB host 110 enter the sleep mode. Before entering the sleep mode, the WUSB host 110 transfers a WUSB channel stop information element (IE) to the WUSB devices 120-1 through 120-3 by sending a micro-scheduled management command (MMC) packet at least three consecutive times. In addition, in order to check a remote wakeup signal sent from any of the WUSB devices 120-1 through 120-3, the WUSB host 110 embeds the WUSB channel stop IE in an MMC packet sent after entering the sleep mode.

To control the operation of the WUSB system 100, a special field, e.g., a WakeupTime field is added to a WUSB channel stop IE. Table 1 shows the format of a WUSB channel stop IE according to an exemplary embodiment of the present inventive concept.

TABLE 1

| Off- | | | | |
|---|---|---|---|---|
| set | Field | Size | Value | Description |
| 0 | bLength | 1 | Constant | Size of this IE: 8 bytes |
| 1 | IE_Identifier | 1 | Constant | WCHANNEL_STOP_IE |
| 2 | bmAttributes | 1 | Bitmap | This field contains |
| | | | | attributes for |
| | | | | channel stop IE. |
| 3 | StopTime | 3 | Timestamp | Time at which WUSB |
| | | | | channel will stop. |
| 4 | WakeupTime | 2 | Timestamp | Time at which next |
| | | | | MMC packet will be |
| | | | | sent (unit: msec). |

The StopTime field of the WUSB channel stop IE informs after how long the WUSB host 110 will stop a WUSB channel and enter the sleep mode. In other words, the StopTime field contains time information about a time at which the WUSB host 110 will enter the sleep mode. The WakeupTime field added to the WUSB channel stop IE according to the current embodiments of the present inventive concept informs after how long the WUSB host 110 will wake up from the sleep mode. In other words, the WakeupTime field contains time information about when the WUSB host 110 will wake up from the sleep mode and send a next MMC packet. The size of the WakeupTime field shown in Table 1 is set to 2 bytes, but the present inventive concept is not restricted thereto.

Among the WUSB devices 120-1 through 120-3, any WUSB device 120-i receiving the MMC packet analyzes the WakeupTime field included in the WUSB channel stop IE embedded in the MMC packet and recognizes when the WUSB host 110 will wake up from the sleep mode and send a next MMC packet. Accordingly, the WUSB device 120-i can exit the sleep mode when the WUSB host 110 wakes up from the sleep mode and sends the next MMC packet to receive the MMC packet, and it can re-enter the sleep mode after receiving the MMC packet.

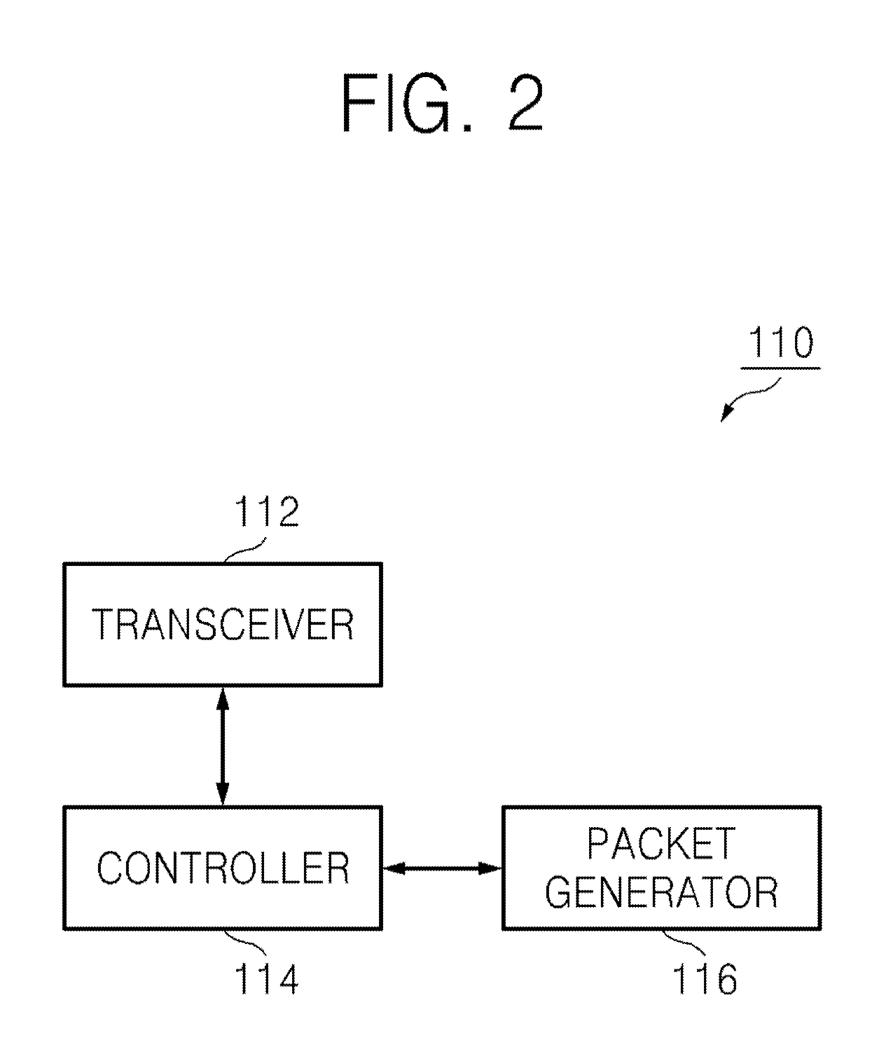

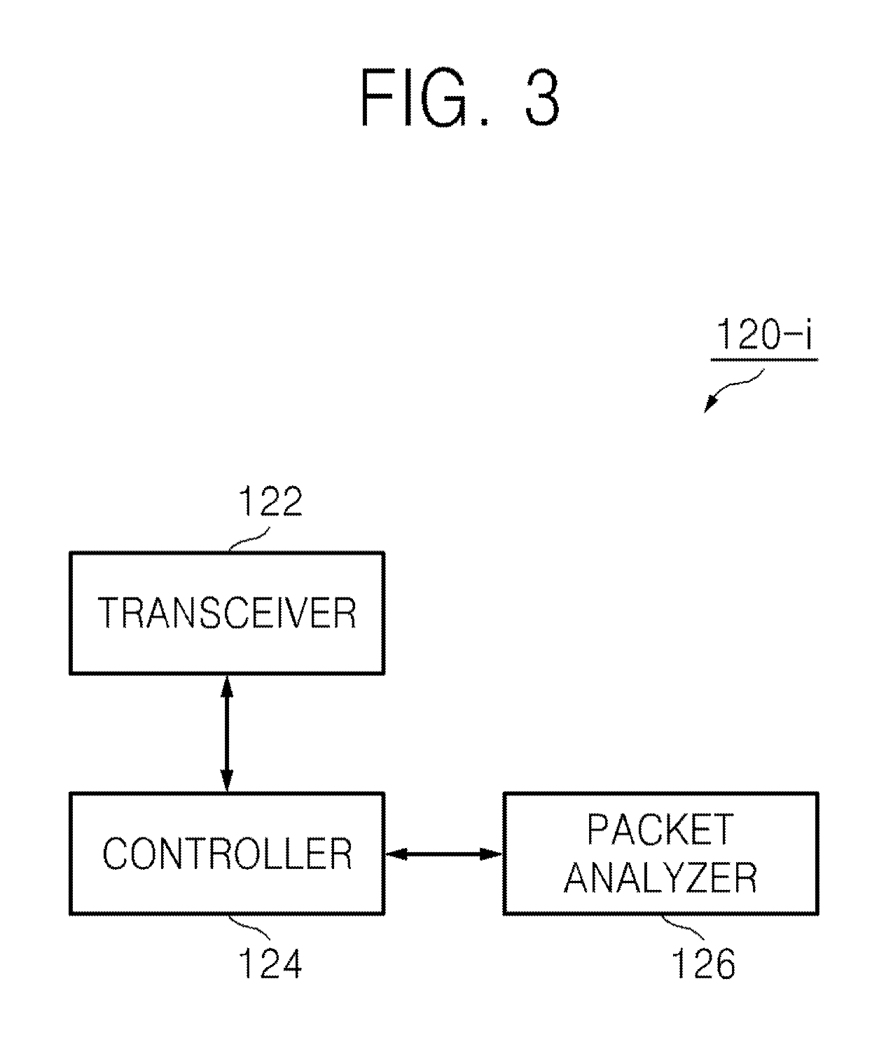

FIG. 2 is a schematic functional diagram of a WUSB apparatus or the WUSB host 110 according to an exemplary embodiment of the present inventive concept. FIG. 3 is a schematic functional diagram of a WUSB apparatus or the WUSB device 120-i according to an exemplary embodiment of the present inventive concept.

Referring to FIG. 2, the WUSB host 110 includes a transceiver 112, a controller 114, and a packet generator 116. The controller 114 controls packet generation and data transmission and reception. The packet generator 116 is controlled by the controller 114 to generate an MMC packet. As described above, the packet generator 116 may generate an MMC packet having a WUSB channel stop IE including the WakeupTime field containing time information about when a next MMC packet will be sent. The controller 114 may calculate the time. The transceiver 112 is controlled by the controller 114 to transmit the MMC packet.

Referring to FIG. 3, the WUSB device 120-i includes a transceiver 122, a controller 124, and a packet analyzer 126. The controller 124 controls packet analysis, data transmission and reception. The transceiver 122 is controlled by the controller 124 to receive an MMC packet sent from the WUSB host 110. The packet analyzer 126 is controlled by the controller 124 to analyze the received MMC packet. The packet analyzer 126 analyzes the WakeupTime field in the WUSB channel stop IE embedded in the MMC packet and extracts time information about when a next MMC packet will be sent. The controller 124 may perform synchronization with the WUSB host 110 based on the time information. For example, the controller 124 may set a sleep mode duration and/or a wakeup time based on a result of the analysis performed by the packet analyzer 126 and thereby control the WUSB device 120-i to enter the sleep mode, maintain the sleep mode, wake up from the sleep mode, and receive the next MMC packet.

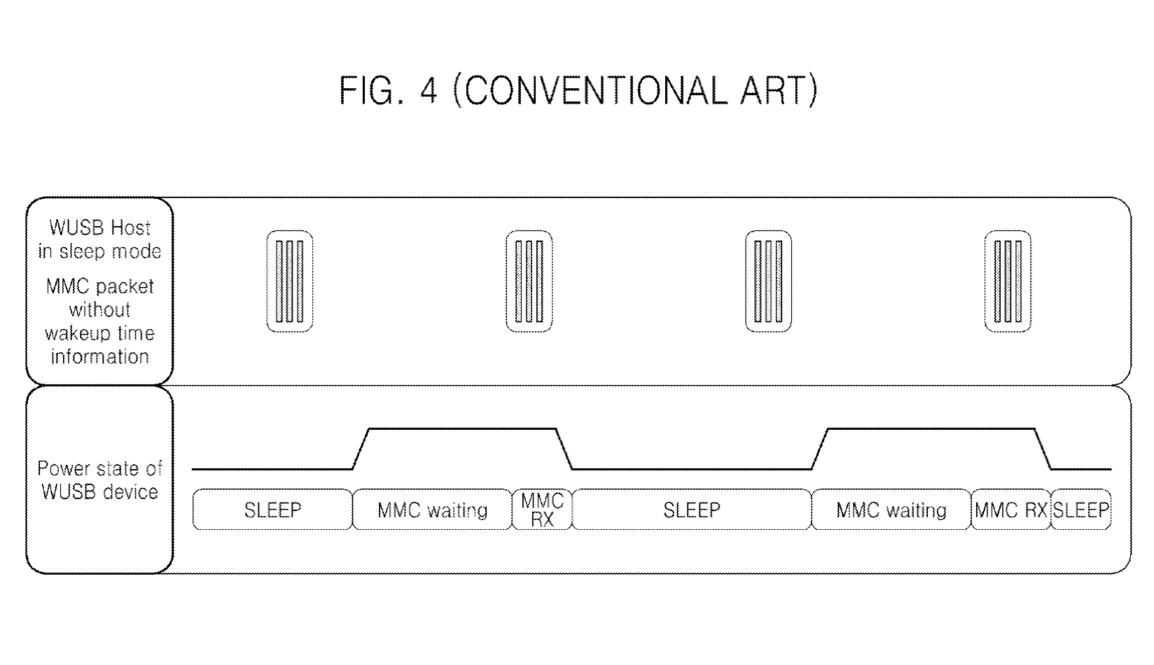

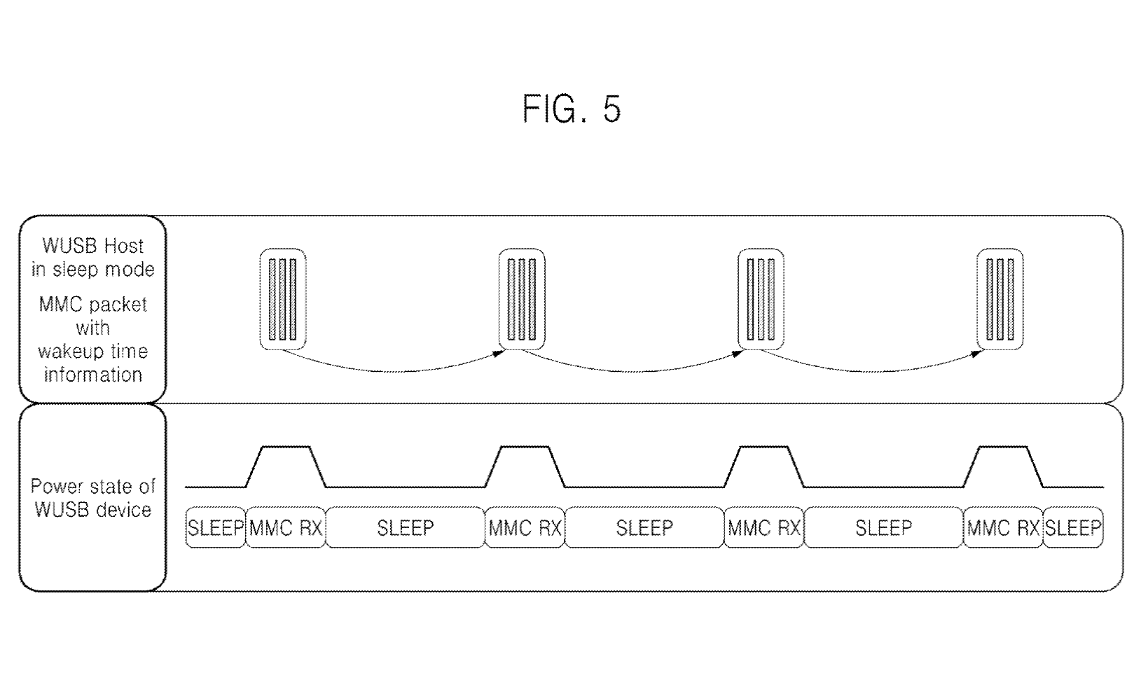

FIG. 4 is a diagram showing the state transition of a conventional WUSB device. FIG. 5 is a diagram showing the state transition of the WUSB device 120-i according to an exemplary embodiment of the present inventive concept.

Referring to FIG. 4, the WUSB host sends an MMC packet at an interval of four seconds in the sleep mode. A WUSB device remains in the sleep mode for four seconds and then wakes up and receives the MMC packet to maintain the connection to the WUSB host. The WUSB device continues a receiving operation after waking up from the sleep mode until receiving the MMC packet. This period, while the WUSB device continues the receiving operation to receive the MMC packet, is an MMC waiting period

If the WUSB host sends the MMC packet just before the WUSB device wakes up, the WUSB device will be continuously running the receiving operation to receive a next MMC packet which will be sent in four seconds, and therefore, the MMC waiting period will be up to four seconds. When the WUSB device has repeated MMC waiting periods, power consumption for sustaining the receiving operation increases. Consequently, the transition to the sleep mode for the reduction of power consumption is compromised.

Referring to FIG. 5, according to an exemplary embodiment of the present inventive concept, when the WUSB host 110 sends an MMC packet containing wakeup time information about when a next MMC packet will be sent in the sleep mode, the WUSB device 120-i can efficiently operate in the sleep mode. In detail, the WUSB device 120-i does not need the MMC waiting period to receive an MMC packet and thereby remains longer in the sleep mode. As a result, power consumption of the WUSB device 120-i is reduced.

When all of the WUSB devices 120-1 through 120-3 connected to the WUSB host 110 enter the sleep mode following the WUSB host 110 entering the sleep mode, the WUSB devices 120-1 through 120-3 can maintain the synchronization with the WUSB host 110 through a WUSB channel stop IE sent from the WUSB host 110.

When the WUSB device 120-i enters the sleep mode before the WUSB host 110 enters the sleep mode, the WUSB device 120-i does not receive the WUSB channel stop IE immediately but, after analyzing a WUSB channel stop IE included in an MMC packet received after waking up from the sleep mode, acquires time information about when a next MMC packet will be sent. At this time, after waking from the sleep mode, the WUSB device 120-i continues the receiving operation for up to four seconds before receiving a first MMC packet since information about when the WUSB host 100 will send the first MMC packet is not known to the WUSB device 120-i until the WUSB device 120-i receives the first MMC packet. Once the first MMC packet is received, the WUSB device 120-i can calculate a period of time while it can remain in the sleep mode before receiving a next MMC packet since it acquires wakeup time information included in the WUSB channel stop IE.

Consequently, the WUSB devices 120-1 through 120-3 can reduce power consumption.

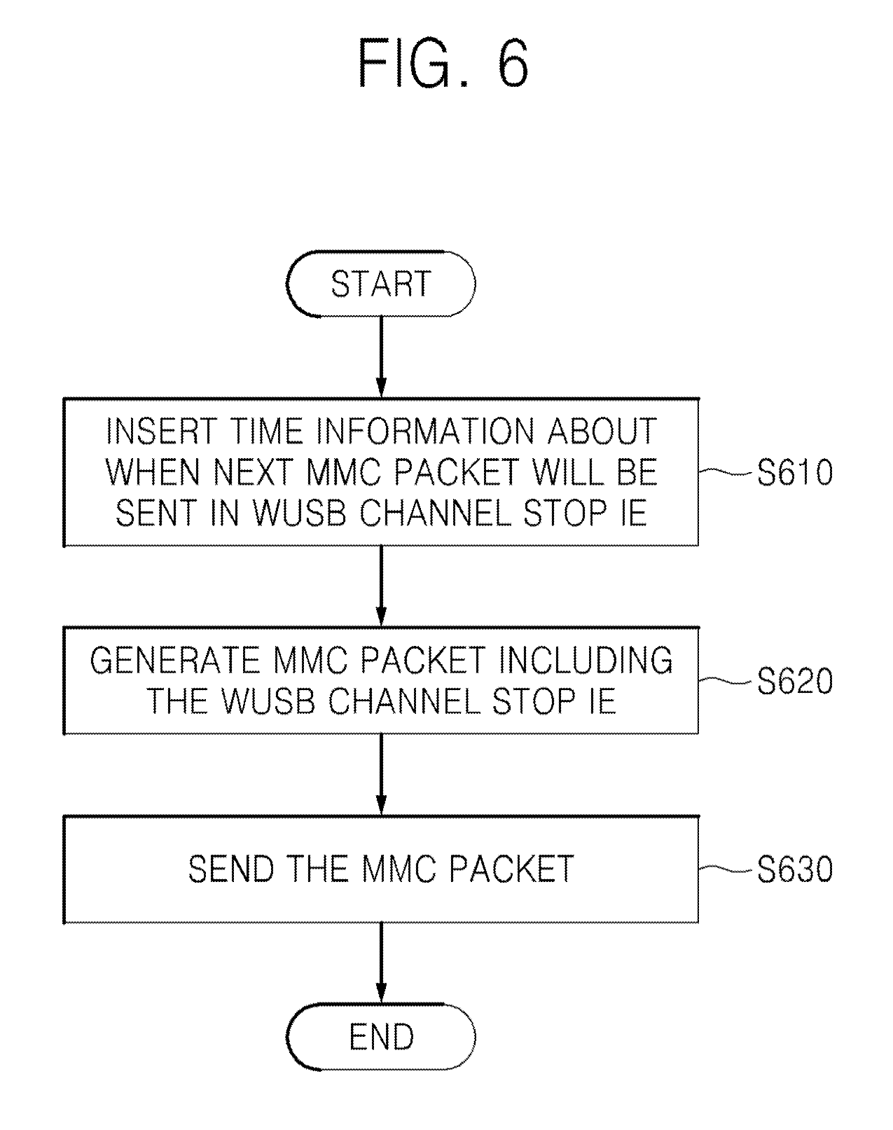

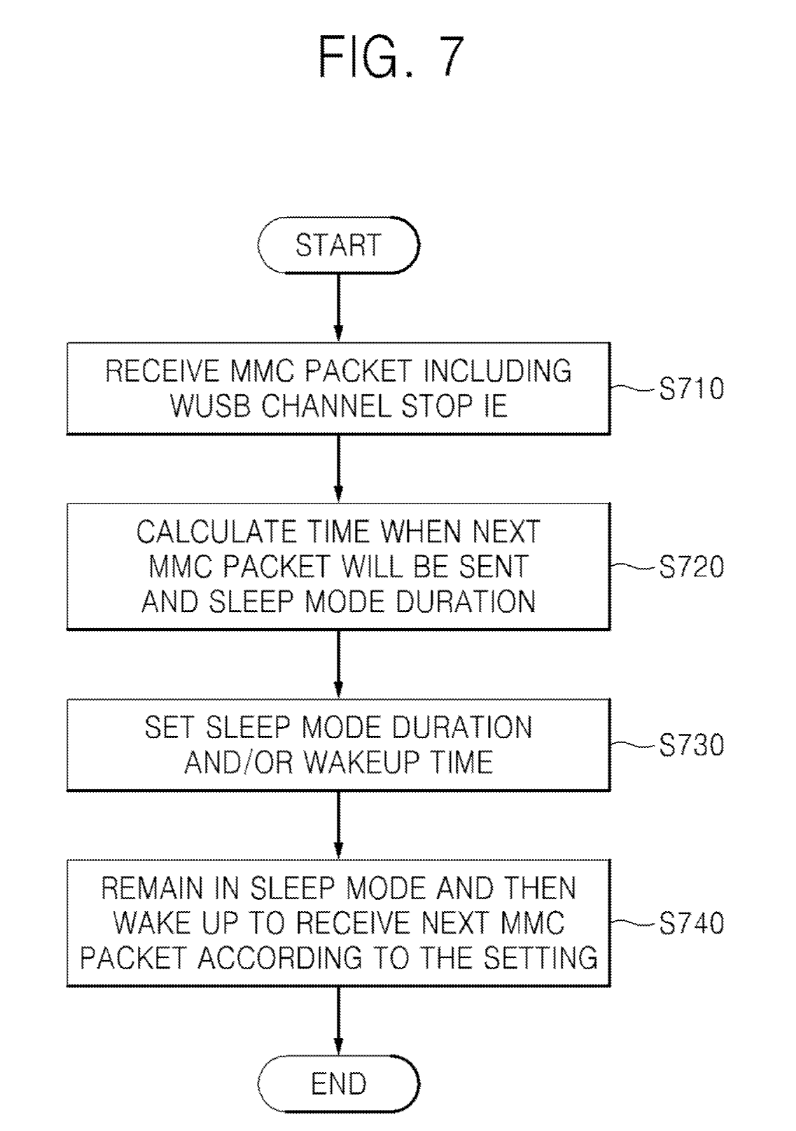

FIG. 6 is a flowchart of an operating method of a WUSB apparatus or the WUSB host 110 according to an exemplary embodiment of the present inventive concept. FIG. 7 is a flowchart of an operating method of a WUSB apparatus or the WUSB device 120-i according to an exemplary embodiment of the present inventive concept.

Referring to FIG. 6, the WUSB host 110 inserts time information about when a next MMC packet will be sent in a WUSB channel stop IE in operation S610. As described above, the time information may be contained in the WakeupTime field of the WUSB channel stop IE. The WUSB host 110 generates an MMC packet including the WUSB channel stop IE in operation S620. The WUSB host 110 sends the MMC packet in operation S630. Operations S610 through S630 may be repeated in a cycle with a predetermined period. As described above, operations S610 through S630 may be repeated so that the MMC packet is sent at an interval of four seconds.

Operations S610 through S630 may performed before or after the WUSB host enters a sleep mode.

Referring to FIG. 7, in operation S710 the WUSB device 120-i receives an MMC packet including a WUSB channel stop IE that the WUSB host 110 sends before entering the sleep mode. When the WUSB device 120-i enters the sleep mode before the WUSB host 110 enters the sleep mode, the MMC packet received in operation S710 is a first MMC packet that the WUSB device 120-i receives after waking up from the sleep mode. When the WUSB device 120-i enters the sleep mode, following the WUSB host 110 entering the sleep mode, the MMC packet received in operation S710 is the MMC packet including the WUSB channel stop IE generated by the WUSB host 110 prior to entering the sleep mode.

The WUSB device 120-i analyzes the MMC packet and calculates a time when a next MMC packet will be sent from the WUSB host 110 and a sleep mode duration in operation S720. As described above, the MMC packet includes a WUSB channel stop IE that includes the WakeupTime field. The WUSB device 120-i analyzes the WakeupTime field of the WUSB channel stop IE included in the MMC packet so as to recognize when the WUSB host 110 will wake up from the sleep mode and send the next MMC packet.

The WUSB device 120-i sets at least one of the sleep mode duration and a wakeup time based on a calculation result in operation S730. The WUSB device 120-i remains in the sleep mode and then wakes up to receive the next MMC packet according to the setting in operation S740.

As described above, according to an exemplary embodiment of the present inventive concept, a WUSB host embeds wakeup time information about when a next MMC packet will be sent in a sleep mode in a current MMC packet, thereby enabling a WUSB device to efficiently enter and wake from its own sleep mode to receive the next MMC packet. As a result, an MMC waiting period while the WUSB device operates to receive an MMC packet between sleep modes is substantially eliminated, and therefore, the WUSB device increases an amount of time in the sleep mode. Consequently, power consumption of the WUSB device is reduced.

The present general inventive concept can also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable transmission medium can transmit carrier waves or signals (e.g., wired or wireless data transmission through the Internet). The computer-readable recording medium can also be distributed over network coupled computer systems so that the computer-readable code is stored and executed in a distributed fashion. Also, functional programs, codes, and code segments to accomplish exemplary embodiments of the present general inventive concept can be easily construed by programmers skilled in the art to which the present general inventive concept pertains.

While the present inventive concept has been particularly shown and described with reference to exemplary embodiments thereof, it will be understood by those of ordinary skill in the art that various changes in forms and details may be made therein without departing from the spirit and scope of the present inventive concept as defined by the following claims.

What is claimed is:

1. An operating method of a wireless universal serial bus (WUSB) apparatus, the operating method comprising:
a WUSB device receiving a micro-scheduled management command (MMC) packet comprising a WUSB channel stop information element (IE) from a WUSB host;
extracting time information from the WUSB channel stop IE about when a next MMC packet will be sent from the WUSB host; and
performing synchronization with the WUSB host based on the time information,

2. The operating method of claim 1, wherein the WUSB channel stop IE contains the time information about when the next MMC packet will be sent.

3. The operating method of claim 1, wherein the time information is inserted in a wakeup time field comprised in the WUSB channel stop IE by the WUSB host.

4. The operating method of claim 1, further comprising received the MMC packet by the WUSB device for a first time after waking up from a sleep mode.

5. The operating method of claim 1, wherein the performance of the synchronization comprises waking the WUSB device from the sleep mode when the WUSB host sends the next MMC packet and receiving the next MMC packet based on the time information.

6. An operating method of a wireless universal serial bus (WUSB) apparatus, the operating method comprising:
a WUSB host inserting time information about when a next micro-scheduled management command (MMC) packet will be sent in a WUSB channel stop information element (IE);
generating an MMC packet comprising the WUSB channel stop IE; and
sending the generated MMC packet to a WUSB device.

7. The operating method of claim 6, further comprising inserting the time information in a wakeup time field comprised in the WUSB channel stop IE.

8. The operating method of claim 6, wherein the insertion of the time information, the generation of the MMC packet, and the sending of the MMC packet are performed before the WUSB host enters a sleep mode.

9. The operating method of claim 6, wherein the insertion of the time information, the generation of the MMC packet, and the sending of the MMC packet are performed after the WUSB host enters a sleep mode.

10. The operating method of claim 6, further comprising sending the next MMC at a time indicated in the time information.

11. A wireless universal serial bus (WUSB) apparatus comprising:
a controller configured to calculate time information about when a next micro-scheduled management command (MMC) packet will be sent;
a packet generator configured to insert the time information in a WUSB channel stop information element (IE) and generate an MMC packet comprising the WUSB channel stop IE; and
a transceiver configured to transmit the MMC packet,

12. The WUSB apparatus of claim 11, wherein a WUSB device in signal communication with the WUSB apparatus receives the MMC packet and performs a synchronization with the WUSB apparatus.

13. A wireless universal serial bus (WUSB) apparatus comprising:
a transceiver configured to receive a micro-scheduled management command (MMC) packet comprising a WUSB channel stop information element (IE) from a WUSB host;
a packet analyzer configured to extract time information from the WUSB channel stop IE about when a next MMC packet will be sent; and
a controller configured to perform synchronization with the WUSB host based on the time information.

14. The WUSB apparatus of claim 13, wherein the WUSB host in signal communication with the WUSB apparatus sends the MMC packet and performs a synchronization with the WUSB apparatus.
